(19) United States
(12) Patent Application Publication
(10) Pub. No.: US 2005/0127544 A1
(43) Pub. Date: Jun. 16, 2005

(54) High-strength dental restorations

(76) Inventors: Dmitri Brodkin, Livingston, NJ (US); Carlino Panzera, Hillsborough, NJ (US); Paul Panzera, Moorestown, NJ (US); Arun Prasad, Cheshire, CT (US); Ajit Karmaker, Wallingford, CT (US); Elie Zammarieh, Wallingford, CT (US); Gregg Daskalon, Orange, CT (US); Martin L. Schulman, Orange, CT (US)

Correspondence Address: Ann M. Knab;Pentron Corporation, 53 North Plains Industrial Road, Wallingford, CT, 06492, US

(21) Appl. No.: 10/961,307

(22) Filed: Oct. 8, 2004

Related U.S. Application Data
(63) Continuation-in-part of application No. 10/347,535, filed on Jan. 17, 2003.
Application No. 10/347,535 is a division of application No. 09/669,348, filed on Sep. 26, 2000, now Pat. No. 6,533,969.
Application No. 09/669,348 is a continuation-in-part of application No. 09/330,665, filed on Jun. 11, 1999, now Pat. No. 6,413,660.
Application No. 10/347,535 is a continuation-in-part of application No. 10/179,881, filed on Jun. 25, 2002, now Pat. No. 6,802,894.
Application No. 10/179,881 is a continuation-in-part of application No. 09/640,941, filed on Aug. 17, 2000, now Pat. No. 6,517,623.
Application No. 09/640,941 is a continuation-in-part of application No. 09/458,919, filed on Dec. 10, 1999, now Pat. No. 6,455,451.
(60) Provisional application No. 60/089,150, filed on Jun. 12, 1998.
(60) Provisional application No. 60/094,612, filed on Jul. 30, 1998.
(60) Provisional application No. 60/153,916, filed on Sep. 14, 1999.
(60) Provisional application No. 60/122,558, filed on Mar. 2, 1999.
(60) Provisional application No. 60/111,872, filed on Dec. 11, 1998.

(51) Int. Cl. A01N 1/00

(52) U.S. Cl. 264/16; 428/15; 65/33.8; 428/688

(57) ABSTRACT

Lithium disilicate based glass-ceramics contain high strength ceramic components for use in the manufacture of dental products. The glass-ceramics have good pressability, i.e., the ability to be formed into dental products by heat-pressing using commercially available equipment. The strength of the dental articles is increased with the inclusion of the high strength ceramic components.

### CROSS-REFERENCE TO RELATED APPLICATIONS

This application is a continuation-in-part application of U.S. application Ser. No. 10/347,535 filed Jan. 17, 2003, which is a division of U.S. application Ser. No. 09/669,348 filed Sep. 26, 2000, now U.S. Pat. No. 6,533,969 B1, which is a continuation-in-part of U.S. application Ser. No. 09/330,665 filed Jun. 11, 1999, now U.S. Pat. No. 6,413,660 B1, which claims priority to U.S. Provisional Application Ser. No. 60/089,150 filed Jun. 12, 1998 and U.S. Provisional Application Ser. No. 60/094,612 filed on Jul. 30, 1998 and is a continuation-in-part of U.S. application Ser. No. 10/179,881 filed Jun. 25, 2002, which is a continuation-in-part application of U.S. application Ser. No. 09/640,941, filed Aug. 17, 2000, now U.S. Pat. No. 6,517,623, which is a continuation-in-part of U.S. application Ser. No. 09/458,919, filed Dec. 10, 1999, now U.S. Pat. No. 6,455,451 B1, which claims priority to U.S. Provisional Application No. 60/153,916, filed Sep. 14, 1999, U.S. Provisional Application No. 60/122,558, filed Mar. 2, 1999, and U.S. Provisional Application No. 60/111,872, filed Dec. 11, 1998, all of which are hereby incorporated by reference.

### TECHNICAL FIELD

The present invention relates generally to dental restorations and more specifically to bonding layers for ceramic components used in dental restorations and methods of making thereof. The invention is also directed to high strength ceramic components embedded in composite materials or ceramic materials for use as dental materials.

### BACKGROUND OF THE INVENTION

Strength and reliability are important factors to consider when manufacturing dental restorations. Dental restorations must be able to withstand the normal mastication forces and stresses that exist within an oral environment. Different stresses are observed during mastication of different types of food, which can be experimentally measured by placing, for example, a strain gauge in inlays on the tooth. Stresses differ depending not only on the type of food, but also on the individual. For example, stress values may range from 570 to 2300 lb/inch² for a single chewing thrust on a piece of meat and from 950 to 2400 lb/inch² for a single thrust on a biscuit. The physical properties of dental restorations must be adequate to withstand the stresses applied by the repetitive forces of mastication.

Ceramic materials have proven to be reliable in the fabrication of single unit dental restorations. U.S. Pat. No. 4,798,536 to Katz and an article by Kabbert and Knode entitled “Inceram: Testing a New Ceramic Material”, Vol.4, pp 87-97 (1993) each disclose ceramic compositions having leucite therein to provide strength and reliability to dental restorations. The strength of the materials is in the area of 170 MPa which is much higher than that of conventional porcelain which exhibits strengths of about 70 MPa. Nevertheless, the strength and/or toughness values of the aforementioned ceramic materials may not be adequate for the fabrication of multiple unit restorations.

There is a need to provide high strength, ceramic restorations having structural integrity and reliability and optimum bonding properties. It is desirable to produce high strength ceramic restorations which are compatible with a wide range of cost-effective polymeric based dental materials.

### SUMMARY OF THE INVENTION

These and other objects and advantages are accomplished by the composition and method of manufacture of the present invention directed to high strength ceramic components for use in dental applications. In accordance with one embodiment herein, a bonding layer is disposed on a ceramic component to increase the bonding properties of the ceramic component in order that the ceramic component may better bond to a resin material, ceramic material or composite material. Moreover, the bonding layer provides strength to the ceramic component by forming a compressive layer thereon.

In accordance with another embodiment herein, a ceramic component is partially or fully embedded or encapsulated in composite material. The ceramic component is bonded to the composite material either by mechanical means, chemical means or both. The composite material may be placed directly on the ceramic component. Alternatively, the structural component is coated with a bonding layer to provide adhesion between the composite or like material and the structural component.

In accordance with yet another embodiment herein, silicon dioxide is deposited on the surface of the structural component in the form of colloidal silica, silane, tetra ethyl orthosilicate, or a similar silica precursor and heat treated to form a bonding layer which bonds the structural component to a resin, ceramic or composite material.

In accordance with still yet another embodiment, one or more layers of ceramic material are disposed on a high strength ceramic component to provide a dental restoration. The ceramic material may be applied in the form of powder, putty, tape or a pellet.

In accordance with yet one more embodiment, a glass-ceramic material is formed around a high strength ceramic component.

The resultant structural component is useful in the fabrication of dental appliances and restorations such as orthodontic retainers, bridges, space maintainers, tooth replacement appliances and splints.

### BRIEF DESCRIPTION OF THE DRAWINGS

Features of the present invention are disclosed in the accompanying drawings, wherein similar reference characters denote similar elements throughout the several views, and wherein:

FIG. 1 shows a ceramic bar and bonding layer in accordance with the present invention;

FIG. 2 shows a ceramic bar embedded in composite material in accordance with the present invention;

FIG. 3 shows a cross-sectional view at line 2-2 of the component in FIG. 2;

FIG. 4 shows a ceramic bar with a bonding layer deposited thereon and embedded in composite material in accordance with the present invention;

FIG. 5 shows a ceramic bar partially embedded in composite material in accordance with the present invention;

FIG. 6 shows a curved ceramic bar embedded in composite material in accordance with the present invention;

FIG. 7 shows a curved ceramic bar embedded in composite material that follows the contour of the ceramic bar in accordance with the present invention;

FIG. 8 shows the size and shape of a bar which was used in the examples herein in accordance with the present invention;

FIG. 9 shows a veneering material on the bar of FIG. 8 which was used in the examples for testing bond strength in accordance with the present invention;

FIG. 10 shows a dental restoration having a reinforcing component therein and positioned on a mold in accordance with the present invention;

FIG. 11 shows a piece of ceramic tape that may be applied on the reinforcing component in FIG. 10 to form the dental restoration in accordance with the present invention;

FIG. 12 shows ceramic putty that may be applied on the reinforcing component in FIG. 10 to form the dental restoration in accordance with the present invention;

FIG. 13 shows ceramic powder that may be applied on the reinforcing component in FIG. 10 to form the dental restoration in accordance with the present invention;

FIG. 14 shows a structural component prior to cutting or grinding in accordance with the present invention;

FIG. 15 shows a dental restoration with a reinforcing component therein in accordance with the present invention;

FIG. 16 shows a mold with a reinforcing component therein after the lost wax process and prior to the introduction of ceramic material by for example, injection molding in accordance with the present invention;

FIG. 17 shows a dental restoration formed from the die of FIG. 16 in accordance with the present invention;

FIG. 18 shows a dilatometer graph showing the coefficients of thermal expansion for materials used herein in accordance with the present invention;

FIG. 19 is a perspective view of a plunger system in a pressing furnace for use in the fabrication of a dental restoration in accordance with the present invention;

FIG. 20 shows a dental restoration having a reinforcing component therein and positioned on a mold, wherein the reinforcing bar has a shape that approximates the near net shape of the dental restoration in accordance with the present invention; and

FIG. 21 shows a dental restoration having a reinforcing bar of shape approximating the near net shape of the dental restoration in accordance with the present invention.

### DETAILED DESCRIPTION OF THE INVENTION

The present invention is directed to high-strength structural ceramic components for use in dental applications. In one embodiment herein, a high-strength structural component is provided having a bonding layer disposed thereon. The bonding layer is deposited on the ceramic component to increase the bonding properties of the ceramic component in order that the ceramic component may better bond to a resin material, ceramic material or composite material such as commercially available Sculpture® composite from Pentron Laboratory Technologies, LLC, Wallingford, Conn. or commercially available OPC® porcelain from Pentron Laboratory Technologies, LLC, Wallingford, Conn. or lithium disilcate glass-ceramic material. Moreover, the bonding layer provides strength to the ceramic component by forming a compressive layer thereon. The resultant structural component is useful in the fabrication of dental appliances and restorations such as orthodontic retainers, bridges, space maintainers, tooth replacement appliances and splints and further as restorations as set forth in U.S. Pat. No. 5,614,330 to Panzera et al., U.S. Pat. Nos. 4,717,341 and 4,894,012 to Goldberg, and commonly assigned U.S. Pat. No. 6,120,591, all of which are incorporated by reference herein.

The structural components may be fabricated of a high strength ceramic material such as, but not limited to, alumina, zirconia, SIALON, mullite, titanium oxide, magnesium oxide and composites or mixtures thereof. The flexural strength of the ceramic components is typically greater than about 400 MPa and preferably in the range of about 500 MPa to about 1200 MPa. The structural components are preferably in the form of bars or pontics. The bars may be of any cross-sectional configuration effective to provide strength and stiffness to the finished dental appliance. Examples of cross-sectional configurations of the bars include square, rectangular, triangular, rhomboidal, ovoidal, and cylindrical shapes. The bars may be straight or curved depending upon the placement or use thereof.

In accordance with one embodiment herein, the structural components are in a shape roughly approximating the near net shape of the dental restoration. These high strength reinforcing components may be machined into a shape which follows the contour of the dental restoration to be made. FIG. 20 shows a structural component 200 having a shape approximating the near net shape of the mold 202 upon which it is positioned. FIG. 21 shows a dental product 204 having a structural component or high strength reinforcing component 206 integrated in the dental product. The structural component 206 has a shape that roughly approximates the near net shape of the dental product 204.

In accordance with one embodiment of the method of the invention, the structural components are coated with a bonding layer to provide adhesion between a resin or like material and the structural component. It is preferable that the bonding layer be able to easily bond to a coupling agent such as a silane compound. Suitable bonding layers include but are not limited to silica, silicates, aluminates, phosphates, fluorates, aluminosilicates, silica-rich glasses, zirconates and titanates. One preferable silicate material to be used as the bonding layer comprises lithium disilicate such as material used to make commercially available OPC® 3G® ceramic pellets available from Pentron Laboratory Technologies, LLC, Wallingford, Conn. Preferably, silica containing materials such as porcelain materials such as commercially available ColorMatch® porcelain from Pentron Laboratory Technologies, LLC, Wallingford, Conn. and Vitadurn™ porcelain from Vita Zahnfabrik, Bad Sackingen, Germany or silica are used as the bonding layer. The layer may be applied in any known manner including, but not being limited to, a sol/gel deposition followed by pyrolysis, fusing, sputtering, chemical vapor deposition, ion bombardment, and vacuum deposition. If the bonding layer is fused to the structural component, the fusion temperature should be lower than that of the structural component. The fusion temperature of the bonding material is typically in the range of about 400° C. to about 1500° C. Moreover, it is preferable that the bonding layer has a coefficient of thermal expansion slightly lower than that of the structural component. Furthermore, it is desirable that the bonding layer exhibits good wetting properties.

In a preferred embodiment herein, the materials set forth above that are used as the bonding layer may be applied to the structural component and used alone as the outer layer to make a core of a dental restoration without the addition of other materials. One or more layers of material may be applied in the form of a pellet, powder, putty or tape. The layer or layers are applied at a thickness in the range from about 0.1 to about 8.0 mm and more preferably from about 0.3 to about 5.0 mm and most preferably from about 0.4 to about 1.5 mm. Commonly owned, copending U.S. patent application Ser. No. 09/653,377 filed Sep. 1, 2000, now U.S. Pat. No. 6,648,645, is directed to putty and tape formulations and is hereby incorporated by reference. Moreover, the material may be in powder form or pellet form such as those materials disclosed in copending, commonly owned U.S. patent application Ser. No. 09/458,919 filed Dec. 10, 1999, now U.S. Pat. No. 6,455,451, and U.S. patent application Ser. No. 09/640,941 filed Aug. 17, 2000, now U.S. Pat. No. 6,517,623, which are hereby incorporated by reference. Depending on the form of the material to be applied to the structural component, the method of application may include any known method such as a sol/gel deposition followed by pyrolysis, fusing, sputtering, chemical vapor deposition, ion bombardment, vacuum deposition, hammering, bending, wrapping, shaping and pressing, by application of pressure by hand or with the use of utensils or pressing equipment such as an isostatic, hot or cold pressing machine. In one example of this preferred embodiment, zirconia bars are used as reinforcement for dental restorations. Zirconia bars may be ground by using diamond and alumina tools to form the desired shape. Lithium disilicate glass-ceramic material such as OPC®3G® pressable ceramic available from Pentron Laboratory Technologies, LLC, Wallingford, Conn., is applied to the zirconia bar by pressing the material into a mold fabricated around the zirconia bar.

In accordance with a second embodiment of the method of the invention, silicon dioxide is deposited on the surface of the structural component in the form of colloidal silica, silane, tetra ethyl orthosilicate, or a similar silica precursor. The silicon dioxide may be pure silicon dioxide. The component with the layer thereon is heated to a sufficiently high temperature in the range of about 400° C. to about 1400° C., preferably about 600° C. to about 1300° C. to allow the silica to react with the structural component to form a bond. For example, if the structural component comprises alumina, the silica reacts therewith to form a thin layer of mullite. If the structural component comprises zirconia, the silica reacts therewith to form zircon. The mullite and zircon each possess a lower thermal expansion than the alumina and zirconia, respectively, thereby forming a compressive layer on the structural components further increasing the strength.

In accordance with the method herein, the bonding layer can be abraded or etched by methods known in the art such as sand blasting or acid etching. The layer may then be primed with a coupling agent. U.S. Pat. Nos. 5,444,104, 4,547,531 and 4,544,359 all to Waknine, which are incorporated by reference herein, discuss suitable etching and priming procedures. Suitable coupling agents include silane compounds such as organo-silane agents. Exemplary silane agents include gamma-methacryloxy propyltrimethoxysilane which is available from Osi Specialties, Inc., Friendly, W. Va. under the name Silquest A-174, gamma-aminopropyl triethoxysilane, vinyl trichlorosilane and styrylamine functional silane.

In accordance with yet another embodiment herein, the present invention is directed to a high-strength structural ceramic component partially or fully embedded or encapsulated in composite material. The composite material may be any known composite material such as a resin or polymeric material combined with particulate and/or fiber material. Preferably, the composite is a polymeric material having particulate therein such as commercially available Sculptures composite available from Pentron Laboratory Technologies, LLC, Wallingford, Conn., or polymeric material reinforced with fiber and/or particulate such as commercially available FibreKor® composite from Pentron Laboratory Technologies, LLC, Wallingford, Conn. The ceramic component is bonded to the composite material either by mechanical means, chemical means or both. Mechanical bonding occurs after the ceramic component is embedded in the composite material and the composite material is cured. To aid in the mechanical bonding of the composite material to the ceramic component, the ceramic component may be treated prior to covering with composite material. Treatment may include etching, abrading and the like. Chemical bonding of the ceramic to composite material may involve organically modifying the surface of the ceramic such as through application of a silane or other coupling agent to the surface of the ceramic. Preferably, the composite material completely encapsulates the ceramic component. This then allows for easier carving or grinding or other similar modification to the component to form the shape desired since bridges, space maintainers, tooth replacement appliances and splints each require some customization to adequately fit within the patient's mouth. The ceramic component may be difficult to carve into complicated or difficult shapes. The composite material thereon allows for such modification. The resultant structural component is useful in the fabrication of dental appliances and restorations such as orthodontic retainers, bridges, space maintainers, tooth replacement appliances and splints and further as restorations set forth in U.S. Pat. No. 5,614,330 to Panzera et al., U.S. Pat. Nos. 4,717,341 and 4,894,012 to Goldberg, and commonly assigned U.S. Pat. No. 6,120,591, all of which are incorporated by reference herein.

In accordance with still another embodiment of the method of the invention, the composite material is placed directly on the ceramic component. The composite material may be wound around the ceramic component or molded, pressed or deposited in any known fashion or method. The composite material may be oriented in one or more directions. For example, if fiber reinforced composite material is used, it may be wound around the ceramic component. One layer may be oriented perpendicular to the length of the ceramic component and the next layer may be oriented parallel to the length of the ceramic component, alternating the direction as layers are applied thereto. Commercially available Fibrekor® fiber reinforced composite from Pentron Laboratory Technologies, LLC, Wallingford, Conn. may be used to build the fiber reinforced composite around the ceramic component.

In accordance with an alternative embodiment of the method of the invention, prior to partially or fully encapsulating or embedding the structural component in composite material, the structural component is coated with a bonding layer as set forth above to provide adhesion between the composite material and the structural component. Additionally, the bonding layer provides strength to the ceramic component by forming a compressive layer thereon. A coupling agent may be applied to the structural component prior to application of the bonding layer. It is preferable that the bonding layer be able to easily bond to a coupling agent such as a silane compound. Suitable bonding layers include but are not limited to silica, silicates, aluminates, phosphates, fluorates, aluminosilicates, silica-rich glasses, zirconates and titanates. The layer may be applied in any known manner including, but not being limited to, fusing, sputtering, chemical vapor deposition, ion bombardment, and vacuum deposition. If the bonding layer is fused to the structural component, the fusion temperature should be lower than that of the structural component. Moreover, it is preferable that the bonding layer has a coefficient of thermal expansion slightly lower than that of the structural component. Furthermore, it is desirable that the bonding layer exhibits good wetting properties.

In accordance with yet another embodiment of the method of the invention, prior to partially or fully encapsulating or embedding the structural component in composite material, silicon dioxide is deposited on the surface of the structural component in the form of colloidal silica, silane, tetra ethyl orthosilicate, or a similar silica precursor. The silicon dioxide may be pure silicon dioxide. The component with the layer thereon is heated to a sufficiently high temperature to allow the silica to react with the structural component to form a bond. For example, if the structural component comprises alumina, the silica reacts therewith to form a thin layer of mullite. If the structural component comprises zirconia, the silica reacts therewith to form zircon. The mullite and zircon each possess a lower thermal expansion than the alumina and zirconia, respectively, thereby forming a compressive layer on the structural components further increasing the strength.

The composite material used above may be fully or partially polymerized using photo, chemical or thermal means under controlled pressure or atmospheric pressure. The resin or polymeric component can be selected from those known in the art of dental materials, including those listed in commonly assigned U.S. Pat. No. 6,013,694, which is incorporated by reference herein. The polymeric matrix materials include but are not limited to expandable monomers, liquid crystal monomers, ring-opening monomers, polyamides, acrylates, polyesters, polyolefins, polymides, polyarylates, polyurethanes, vinyl esters or epoxy-based materials. Other polymeric matrices include styrenes, styrene acrylonitriles, ABS polymers, polysulfones, polyacetals, polycarbonates, polyphenylene sulfides, and the like. These polymeric matrices are derived from curing polymeric matrix precursor compositions. Such precursor compositions are well-known in the art, and may be formulated as one-part, two-part, or other compositions, depending on the components.

Preferred materials include those based on acrylic and methacrylic monomers, for example those disclosed in U.S. Pat. No. 3,066,112, No. 3,179,623, and No. 3,194,784 to Bowen; U.S. Pat. No. 3,751,399 and No. 3,926,906 to Lee et al.; and commonly assigned U.S. Pat. No. 5,276,068 to Waknine and U.S. Pat. No. 5,969,000, all of which are herein incorporated by reference in their entirety. Especially preferred methacrylate monomers include the condensation product of bisphenol A and glycidyl methacrylate, 2,2′-bis [4-(3-methacryloxy-2-hydroxy propoxy)-phenyl] propane (hereinafter abbreviated BIS-GMA), the condensation product of ethoxylated bisphenol A and glycidyl methacrylate, (hereinafter EBPA-DMA), and the condensation product of 2 parts hydroxymethylmethacrylate and 1 part triethylene glycol bis(chloroformate) (hereinafter PCDMA). Polyurethane dimethacrylates (hereinafter abbreviated to PUDMA) are also commonly-used principal polymers suitable for use in the present invention.

The polymeric matrix precursor composition may further comprise a co-polymerizable diluent monomer. Such monomers are generally used to adjust the viscosity of the polymerizable composition, which affects wettability of the composition. Suitable diluent monomers include, without limitation, hydroxyalkyl methacrylates, such as 2-hydroxyethyl methacrylate, 1,6-hexanediol dimethacrylate, and 2-hydroxypropyl methacrylate; glyceryl dimethacrylate; ethyleneglycol methacrylates, including ethyleneglycol methacrylate, diethyleneglycol dimethacrylate, triethyleneglycol dimethacrylate and tetraethyleneglycol dimethacrylate; or diisocyanates, such as 1,6-hexamethylene diisocyanate. Triethyleneglycol dimethacrylate (TEGDMA) is particularly preferred for use in the present invention.

The polymeric matrix precursor composition typically includes polymerization initiators, polymerization accelerators, ultra-violet light absorbers, anti-oxidants, fluorescent whitening agents, and other additives well known in the art. The polymer matrices may be visible light curing, self-curing, dual curing, and vacuum-, heat-, and pressure-curable compositions as well as any combination thereof. Visible light curable compositions employ light-sensitive compounds such as benzil diketones, and in particular, dl-camphorquinone in amounts ranging from about 0.05 to 0.5 weight percent. UV absorbers are particularly desirable in the visible light curable compositions in order to avoid discoloration of the resin form any incident ultraviolet light. Suitable UV absorbers are the various benzophenones, particularly UV-9 and UV-5411 available from American Cyanamid Company, and benzotriazoles known in the art, particularly 2-(2′-hydroxy-5′-methylphenyl)-benzotriazole, sold under the trademark TINUVIN P by Ciba-Geigy Corporation, Ardsley, N.Y. in amounts ranging from about 0.05 to about 5.0 weight percent.

In the self-curing compositions, a polymerization accelerator may be included in the polymerizable monomer composition. The polymerization accelerators suitable for use include the various organic tertiary amines well known in the art, generally aromatic tertiary amines, such as dimethyl-p-toluidine, dihydroxyethyl-p-toluidine and the like, in amounts ranging from about 0.05 to about 4.0 weight percent, and generally acrylate derivatives such as dimethylaminoethyl methacrylate and particularly, diethylaminoethyl methacrylate in amounts ranging from about 0.05 to 0.5 weight percent.

The heat and pressure curable compositions include, in addition to the monomeric components, a heat cure initiator such as benzoyl peroxide, 1,1′-azobis(cyclohexanecarbonitrile), or other suitable free radical initiators. Particularly suitable free radical initiators are lauroyl peroxide, tributyl hydroperoxide, AIBN and, more particularly benzoyl peroxide or 1,1′-azobis(cyclohexanecarbonitrile).

The polymeric matrix may further comprise at least one filler known in the art and used in dental restorative materials, including reinforcing fibers as set forth in U.S. Pat. Nos. 4,717,341 and 4,894,012 to Goldberg et al, and copending commonly assigned U.S. application Ser. No. 09/270,853 filed Mar. 17, 1999, now U.S. Pat. No. 6,362,250, all of which are incorporated by reference herein in their entirety. Suitable fillers are those capable of being covalently bonded to the polymeric matrix itself or to a coupling agent that is covalently bonded to both. Examples of suitable filling materials include but are not limited to those known in the art such as silica, silicate glass, quartz, barium silicate, strontium silicate, barium borosilicate, strontium borosilicate, borosilicate, lithium silicate, amorphous silica, ammoniated or deammoniated calcium phosphate and alumina, zirconia, tin oxide, and titania. Particularly suitable fillers for dental filling-type materials prepared in accordance with this invention are those having a particle size ranging from about 0.1-5.0 microns with a silicate colloid of 0.001 to about 0.07 microns and prepared by a series of milling steps comprising wet milling in an aqueous medium, surface etch milling and silanizing milling in a silane solution. Some of the aforementioned inorganic filling materials are disclosed in commonly-assigned U.S. Pat. No. 4,544,359 and No. 4,547,531 to Waknine, the pertinent portions of which are incorporated herein by reference.

The reinforcing fiber element of the polymeric composite preferably comprises glass, carbon, graphite, polyaramid, or other fibers known in the art, such as polyesters, polyamides, and other natural and synthetic materials compatible with the polymeric matrix. Some of the aforementioned fibrous materials are disclosed in commonly assigned copending U.S. Pat. Nos. 4,717,341, 4,894,012 and 6,013,694, all which are incorporated herein by reference. The fibers may further be treated, for example silanized, to enhance the bond between the fibers and the polymeric matrix. The fibers preferably take the form of long, continuous filaments, although the filaments may be as short as 3 to 4 millimeters. Shorter fibers of uniform or random length might also be employed. Preferably, the fibers are at least partially aligned and oriented along the longitudinal dimensions of the wire. However, depending on the end use of the composite material, the fibers may also be otherwise oriented, including being normal or perpendicular to that dimension.

In all embodiments set forth above, the bonding layer may be applied in any thickness sufficient to create a bond between the structural component and the outer resin, ceramic or composite layer. Preferably, the thickness of the bonding layer is about 5 microns to about 100 microns. The layer may be applied to all sides of the structural component or only those sides which will require an outer surface layer thereon to form the dental restoration. Preferably, all sides of the structural component are coated. After the bonding layer has cured, it can be abraded or etched by methods known in the art such as sand blasting or acid etching. The layer may then be primed with a coupling agent. U.S. Pat. Nos. 5,444,104, 4,547,531 and 4,544,359 all to Waknine, which are incorporated by reference herein, discuss suitable etching and priming procedures. Suitable coupling agents include silane compounds such as organo-silane agents. Exemplary silane agents include gamma-methacryloxy propyltrimethoxysilane which is available from Osi Specialties, Inc., Friendly, W. Va. under the name Silquest A-174, gamma-aminopropyl triethoxysilane, vinyl trichlorosilane and styrylamine functional silane.

After application of the coupling agent, the structure may be readily bonded to resin, ceramic or composite material in order to manufacture a dental restoration or appliance.

In accordance with the invention herein, a preferred material to be applied to the high strength reinforcing bar is lithium disilicate (Li₂Si₂O₅). The compositions of the lithium disilicate glass-ceramics comprise inter alia, silica, lithium oxide, alumina, potassium oxide and phosphorus pentoxide in the ranges given in Table 1 below. The glass-ceramic compositions of the invention have a combination of properties useful for dental restorations. The glass-ceramics have good pressability, i.e., the ability to be formed into dental articles by heat pressing, also known as hot pressing, or injection molding, using commercially available equipment. The glass-ceramics also have good formability, i.e., the ability to be applied in powder form to a dental model and heated to form a dental restoration. The glass-ceramics may further be sintered to full density and machined into a dental restoration.

The compositions herein are prepared by mixing, in the desired proportions, the oxides and/or compounds that decompose to form the oxides, followed by fusing the ingredients to obtain lithium disilicate compositions. Convenient raw material include lithium carbonate, silica, alumina, carbonates of potassium, sodium and calcium, ammonium phosphate, tricalcium aluminate, aluminum phosphate or aluminum metaphosphate and if necessary, Ta₂O₅, CeO₂, Tb₄O₇, titanium dioxide, and zirconium dioxide.

The compositions are melted at about 1200° to about 1600° C. and preferably in the range of about 1300° to about 1400° C. for a period of time, preferably for about 4 hours and formed into shaped pieces by methods mentioned above, e.g., into the shape of a pellet (i.e., cylindrical blank) or blanks of other shapes.

The resulting glass pellets are heat-treated to form glass-ceramic pellets using a one or a two-step heat-treatment cycle preferably in the temperature range of about 400° to about 1100° C. This crystallization heat-treatment may comprise a nucleation step and a crystal growth step. Depending on the composition, the first, nucleation step, may be carried out in the range of about 450° C. to about 700° C. and preferably in the range of about 500° C. to about 650° C. for about 0.5 to about 4 hours and the second, crystal growth step, may be carried out in the range of about 800° C. to about 1000° C. and preferably in the range of about 830° C. to about 930° C. for about 0.5 to about 48 hours. The most preferable heat treatment comprises about a one hour soak at about 645° C. and a subsequent four hour soak at about 850° C. The resulting glass-ceramic pellets can be used to make dental restorations.

Alternatively, the starting compositions (such as those set forth in Table 1 below) are melted at about 1200° to about 1600° C. and preferably in the range of about 1300° to about 1400° C. for a period of time, preferably for about 4 hours and thereafter quenched (e.g., water quenched or roller quenched), or alternatively, cooled to crystallization temperature. If the melt is cooled to the crystallization temperature, it may remain in the same furnace. The resulting glass is heat-treated to form glass-ceramics using a one or a two step heat-treatment cycle preferably in the temperature range of about 400° to about 1100° C. This crystallization heat-treatment may comprise a nucleation step and a crystal growth step. Depending on the composition, the first, nucleation step, may be carried out in the range of about 450° C. to about 700° C. and preferably in the range of about 500° C. to about 650° C. for about 0.5 to about 4 hours and the second, crystal growth step, may be carried out in the range of about 800° C. to about 1000° C. and preferably in the range of about 830° C. to about 930° C. for about 0.5 to about 48 hours. The most preferable heat treatment comprises about a one hour soak at about 645° C. and a subsequent four hour soak at about 850° C.

TABLE 1

| Oxide, wt % | Range 1 | Range 2 | Range 3 | Range 4 | Range 5 | Range 6 |
|---|---|---|---|---|---|---|
| SiO₂ | about 62 to about | about 64 to about | about 62-85 | about 64-70 | about 64 to about | about 62 to about |
| | 85 | 70 | | | 70 | 76 |
| B₂O₃ | 0 to about 4.9 | 0 to about 2.7 | 0 to about 4.9 | 0 to about 2.7 | about 0.5 to about | 0 to about 5 |
| | | | | | 3.0 | |
| Al₂O₃ | about 1.5 to about | about 1.5 to about | about 5.1-10 | about 5.2-9.0 | about 1.5 to about | about 1.5 to about |
| | 10 | 6.0 | | | 6.0 | 10 |
| | 0 to about 1.5 | 0 to about 1.5 | 0 to about 1.5 | 0 to about 1.5 | 0 to about 1.5 | 0 to about 1.5 |
| ZnO | 0 to about 5 | 0 to about 2 | 0 to about 5 | 0 to about 2 | — | 0 to about 5 |
| CaO | 0 to about 7 | 0 to about 0.9 | 0 to about 7 | 0 to about 0.9 | 0 to about 0.9 | 0 to about 7 |
| MgO | 0 to about 2 | 0 to about 2 | 0 to about 2 | 0 to about 2 | — | 0 to about 2 |
| BaO | 0 to about 7 | 0 to about 7 | 0 to about 7 | 0 to about 7 | 0 to about 7 | 0 to about 7 |
| SrO | 0 to about 1 | 0 to about 1 | 0 to about 1 | 0 to about 1 | 0 to about 1 | 0 to about 1 |
| Cs₂O | 0 to about 5 | 0 to about 5 | 0 to about 5 | 0 to about 5 | 0 to about 5 | 0 to about 5 |
| Li₂O | about 8 to about | about 10 to about | about 8 to about | about 10 to | 10 to about 15 | about 8 to about |
| | 19 | 15 | 19 | about15 | | 19 |
| K₂O | about 2.5 to about 7 | about 2.5 to about 5 | 0 to about 7 | 0 to about5 | about 2.2 to about 5 | 0 to about 7 |
| Na₂O | 0 to about 5 | 0 to about 3 | 0 to about5 | 0 to about3 | about 0.5 to about 3 | 0 to about 5 |
| TiO₂ | 0 to about 2 | 0 to about 2 | 0 to about 2 | 0 to about 2 | 0 to about 2 | 0 to about 2 |
| ZrO₂ | 0 to about 3 | 0 to about 3 | 0 to about 3 | 0 to about 3 | 0 to about 3 | 0 to about 3 |
| P₂O₅ | about 0.5 to about | about 2 to about 7 | about 0.5 to about | about 2 to about 7 | about2 to about 7 | about 0.3 to about |
| | 12 | | 12 | | | 7.0 |
| SnO₂ | 0 to about 1 | 0 to about 1 | 0 to about 1 | 0 to about 1 | 0 to about 1 | 0 to about 1 |
| Sb₂O₃ | 0 to about 1 | 0 to about 1 | 0 to about 1 | 0 to about 1 | 0 to about 1 | 0 to about 1 |
| Y₂O₃ | 0 to about 3 | 0 to about 3 | 0 to about 3 | 0 to about 3 | 0 to about 3 | 0 to about 3 |
| CeO₂ | 0 to about 1 | 0 to about 1 | 0 to about 1 | 0 to about 1 | 0 to about 1 | 0 to about 1 |
| Eu₂O₃ | 0 to about 1 | 0 to about 1 | 0 to about 1 | 0 to about 1 | 0 to about 1 | 0 to about 1 |
| Tb₄O₇ | 0 to about 1 | 0 to about 1 | 0 to about 1 | 0 to about 1 | 0 to about 1 | 0 to about 1 |
| Nb₂O₅ | 0 to about 2 | 0 to about 2 | 0 to about 2 | 0 to about 2 | 0 to about 2 | 0 to about 2 |
| Ta₂O₅ | 0 to about 2 | 0 to about 2 | 0 to about 2 | 0 to about 2 | 0 to about 2 | about 0.5 to about |
| | | | | | | 8.0 |

The glass-ceramics comprise lithium disilicate. The resulting glass-ceramics are then pulverized into powder sieved to −200 mesh to provide powder with average particle sizes of about 30 to about 40 microns. Pigments, fluorescing agents, opacifying agents, and the like may be added to the powder in a wide range in an amount between about 0 and about 6 wt % and preferably in the amount of between about 0 and about 5 wt % and most preferably in the amount of about 0% to about 3 wt %. Moreover, reinforcing agents may be added to the powder in an amount of from about 0 to about 30 vol % and more preferably in an amount of from about 0 to about 20 vol %. The reinforcing agents may include fibers, whiskers, and particulate fillers and may be fabricated of any known material, preferably a glass or ceramic material. The powders may be used in powder form to produce a dental material or may be used to form and fuse (sinter) pressable pellets and/or blanks of desired shapes, sizes and structures.

Sintering of the pellets or blanks is carried out at temperatures in the range of about 8000 to about 1000° C., and preferably in the range of about 850° to about 950° C. Sintering imparts sufficient strength for handling of the pellets or blanks. These pellets and blanks may be used for pressing cores or other frameworks or shapes for dental products or restorations. The cores may be provided with one or more coatings. The coatings may be selected from a ceramic, a sintered ceramic, a glass-ceramic, a porcelain, a glass, a glaze, a composite and mixtures thereof. The coatings preferably have a firing temperature in the range of about 700° C. to about 900° C. and a coefficient of thermal expansion (measured from room temperature to its transition temperature) of within about ±2.0×10⁻⁶/° C. of the dental core (measured at the same temperature range). The blank or pellet may be subjected to viscous deformation at a temperature in the range of about 800° to about 1200° C., and more preferably in the range of about 850° to about 950° C., and most preferably at less than about 930° C., under vacuum and with the application of pressure of between about 2 to about 8 bar (0.2-0.8 MPa) and preferably no greater than about 6 bar (0.6 MPa) to obtain a dental restoration. Moreover, it is possible that the blanks may be machined to a dental restoration of desired geometry using commercially available milling equipment such as the Maho HGF 500 5 Axis CNC Milling Machine available from Fraunhofer Institut Produktionstechnologie, Germany. When powder is used to fabricate dental restorations, the powder is applied to the mold using refractory die techniques or the platinum foil technique.

In an alternative method herein, the compositions in Table 1 are melted at about 1200° to about 1600° C. and preferably in the range of about 1300° to about 1400° C. for a period of time, preferably for about 4 hours and thereafter water quenched or cast into steel molds forming ingots or blanks. The cast glass is annealed at temperatures in the range of 300° to about 600° C. for a time in the range of about 15 minutes to about 8 hours.

The quenched glass is comminuted to a powder. Pigments, fluorescing agents, opacifying agents, and the like may be added to the powder in a wide range in an amount between about 0 and about 6 wt % and preferably in the amount of between about 0 and about 5 wt % and most preferably in the amount of about 0% to about 3 wt %. Moreover, reinforcing agents may be added to the powder in an amount of from about 0 to about 30 vol. % and more preferably in an amount of from about 0 to about 20 vol. %. The reinforcing agents may include fibers, whiskers, and particulate fillers and may be fabricated of any known material, preferably a ceramic material. The powder is compacted into a pellet or starting blank.

The blanks made from the different methods discussed above are thereafter simultaneously sintered and crystallized. Heat treatment may be one or more cycles in the temperature range of about 400° to about 1100° C. The crystallization may comprise a nucleation step and a crystal growth step. Depending on the composition, the first, nucleation step, may be carried out in the range of about 450° C. to about 700° C. and preferably in the range of about 500° C. to about 650° C. for about 0.5 to about 4 hours and the second, crystal growth step, may be carried out in the range of about 800° C. to about 1000° C. and preferably in the range of about 830° C. to about 930° C. for about 0.5 to about 48 hours. The most preferable heat treatment comprises about a one hour soak at about 645° C. and a subsequent four hour soak at about 850° C.

The blank or pellet may be subjected to viscous deformation at a temperature in the range of about 800° to about 1200° C., and more preferably in the range of about 850° to about 950° C., and most preferably at less than about 930° C., under vacuum and with the application of pressure of about between about 2 to about 8 bar (0.2-0.8 MPa) and preferably no greater than 6 bar (0.6 MPa) to obtain a dental restoration. Moreover, it is possible that the blanks may be machined to a dental restoration of desired geometry.

To achieve the required combination of properties, namely sufficient strength, formability below 950° C., by heat-pressing using commercially available dental presses such as the Autopress® Plus available from Pentron Laboratory Technologies, LLC, Wallingford, Conn., translucency and chemical durability, the optimal chemical combinations and crystallization treatment of the present invention are necessary. The best properties are obtained when the lithium metasilicate (Li₂SiO₃) and silica phases are nearly absent, the volume fraction of Li₃PO₄ is less than about 5% and the volume fraction of lithium disilicate (Li₂Si₂O₅) is between about 35% and about 60%. High aspect ratio morphology of the lithium disilicate phase is important and is believed to enhance mechanical properties, i.e., strength and fracture toughness of the glass-ceramic.

Li₂O and SiO₂ are instrumental in crystallizing the required amount of the lithium disilicate phase in the compositions of the present invention. Additionally, BaO and Cs₂O stabilize the residual glass and boost the refractive index of the residual glass to match that of lithium disilicate. Al₂O₃ and to a lesser extent, B₂O₃, if less than 3%, yield chemically durable glass-ceramics that exhibit a sufficiently low solubility. Alkali (Na, K, Cs) and alkaline earth metal (Ca, Ba) oxides are required to lower processing temperatures of the glass-ceramic. However some of them affect chemical durability more than others. With respect to the following group of alkali metals and alkaline earth metals of potassium, calcium, sodium, and barium; potassium is associated with the smallest decrease in chemical durability of lithium containing glasses, with calcium being next, and sodium and barium affecting chemical durability the most. However, the best combination of properties is achieved when those oxides are used in combination to achieve the so-called “mixed alkali effect.” F lowers the viscosity of the glass-matrix and enhances formability at temperatures below about 950° C. Y₂O₃ in combination with Ce₂O₃, Eu₂O₃ and Tb₄O₇ modify the refractive index as well as impart fluorescence. Nb₂O₅ and Ta₂O₅ modify the refractive index as well as aid nucleation and chemical durability of the resulting glass-ceramics. The following Table 2 illustrates examples of the invention.

TABLE 2

| Oxide, wt % | Ex. 1 | Ex. 2 | Ex. 3 | Ex. 4 | Ex. 5 | Ex. 6 | Ex. 7 | Ex. 8 | Ex. 9 | Ex. 10 |
|---|---|---|---|---|---|---|---|---|---|---|
| SiO₂ | about | about | about | about | about | about | about | about | about | about |
| | 68.8 | 70.0 | 70.1 | 68.1 | 69.5 | 68.8 | 65 | 67.2 | 68.9 | 72 |
| B₂O₃ | about | about | — | — | about | about | about | about | about | about |
| | 1.2 | 1.0 | | | 1.3 | 1.3 | 1.0 | 1.2 | 0.9 | 2.0 |
| Al₂O₃ | about | about | about | about | about | about | about | about | about | about |
| | 4.8 | 4.9 | 5.2 | 4.7 | 4.8 | 4.8 | 5 | 4.7 | 4.7 | 4.5 |
| F | — | — | — | — | — | — | — | — | — | — |
| ZnO | — | — | — | — | — | — | — | — | — | — |
| CaO | about | about | about | about | about | about | about 1 | about 1 | about | 0 |
| | 0.9 | 0.5 | 2.2 | 2.0 | 2.0 | 1.0 | | | 0.5 | |
| MgO | — | — | — | — | — | | | | | |
| BaO | about | about | — | — | — | about | about | about | about | about |
| | 2.8 | 1.4 | | | | 2.8 | 2.7 | 2.7 | 1.4 | 2.0 |
| SrO | — | — | — | — | — | — | — | — | — | — |
| Cs₂O | — | — | — | — | — | — | — | — | — | — |
| Li₂O | about | about | about | about | about | about | about | about | about | about |
| | 14.4 | 14.7 | 14.7 | 14.3 | 14.6 | 14.4 | 15 | 14.1 | 14.3 | 13.0 |
| K₂O | about | about | about | about | about | about | about | about | about | about |
| | 2.5 | 2.5 | 4.6 | 4.4 | 4.5 | 2.2 | 2.2 | 2.2 | 2.0 | 2.0 |
| Na₂O | about | about | — | — | — | about | about | about | about | — |
| | 1.4 | 1.4 | | | | 1.5 | 1.4 | 1.4 | 1.3 | |
| TiO₂ | — | — | — | — | — | — | — | — | — | — |
| ZrO₂ | — | — | — | — | — | — | — | — | — | — |
| P₂O₅ | about | about | about | about | about | about | about | about | about | about |
| | 3.3 | 3.6 | 3.4 | 3.3 | 3.4 | 3.3 | 3.5 | 3.2 | 3.5 | 3.0 |
| SnO₂ | — | — | — | — | — | — | — | — | — | — |
| Sb₂O₃ | — | — | — | — | — | — | — | — | — | — |
| Y₂O₃ | — | — | — | — | — | — | — | — | — | about |
| | | | | | | | | | | 0.5 |
| CeO₂ | — | — | — | about | — | — | about | about | about | about |
| | | | | 0.4 | | | 0.4 | 0.4 | 0.3 | 0.6 |
| Eu₂O₃ | — | — | — | — | — | — | — | — | — | about |
| | | | | | | | | | | 0.6 |
| Tb₄O₇ | — | — | — | about | — | — | about | — | about | — |
| | | | | 0.8 | | | 0.9 | | 0.3 | |
| Nb₂O₅ | — | — | — | — | — | — | — | — | — | — |
| Ta₂O₅ | — | — | — | about | — | — | about | about | about | — |
| | | | | 2.0 | | | 1.9 | 2.0 | 1.8 | |
| Molar ratio | about | about | about | about | about | about | about | about | about | about |
| of (Na₂O + K₂O + CaO + SrO + | 1.772 | 1.398 | 1.727 | 1.787 | 1.772 | 1.777 | 1.66 | 1.765 | 1.307 | 0.777 |
| BaO):(ZnO + Al₂O₃) | | | | | | | | | | |
| Three-Point | | | | | | 420 ± 60 | | 440 ± 60 | | 400 ± 50 |
| Flexural Strength | | | | | | | | | | |
| per ISO 6872, MPa | | | | | | | | | | |
| As-pressed Opacity | | | | | | 42 | | 25 | | 34 |
| (relative opacity units) | | | | | | | | | | |
| CTE | | 10.4 | | | | 10.1-10.6 | | 10.5 | 10.0 | 9.9 |
| (25° C.-500° C.), | | | | | | | | | | |
| 10⁻⁶/° C.⁻¹ | | | | | | | | | | |

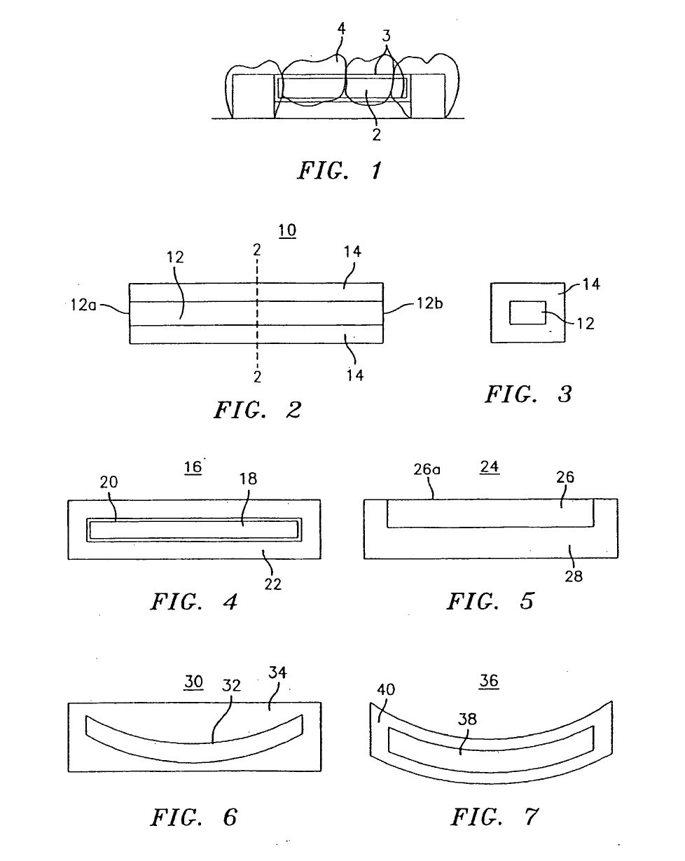

FIGS. 1 through 7 show examples of dental materials manufactured in accordance with the present invention. FIG. 1 shows a cross-sectional view of a ceramic component 2 with a bonding layer 3 thereon and resin material 4 formed on bonding layer 3. FIG. 2 shows a cross-sectional view of a dental material 10 comprising a ceramic component 12 partially embedded in particulate filled composite material 14. All sides of component 12 are embedded except for ends 12a and 12b which are exposed and not covered by composite material 14. FIG. 3 is a cross-sectional view of FIG. 2 at line 2-2. FIG. 4 shows a cross-sectional view of a dental material 16 having a ceramic component 18 covered with a bonding layer 20 and fully embedded on all sides in a fiber reinforced composite material 22. FIG. 5 shows a cross-sectional view of a dental material 24 with a ceramic component 26 partially embedded in composite material 28. The upper side 26a of ceramic component 26 is exposed. FIG. 6 shows a cross-sectional view of a dental material 30 comprising a ceramic component 32 fully embedded in fiber reinforced composite material 34. FIG. 7 shows a cross-sectional view of a dental material 36 having a ceramic component 38 fully embedded in fiber reinforced composite material 40 which follows the contour of the ceramic material 38. In each of the FIGURES, the coated structural materials shown may be further modified by grinding, cutting, sawing, machining or likewise modifying to any shape desired to fabricate a dental appliance or restoration. The outer composite material is easy to work with in comparison to the ceramic component which may be difficult to cut or grind. The outer material may be easily cut to any desired shape or size.

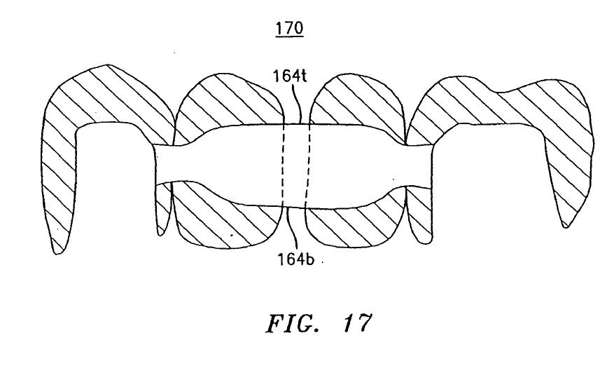

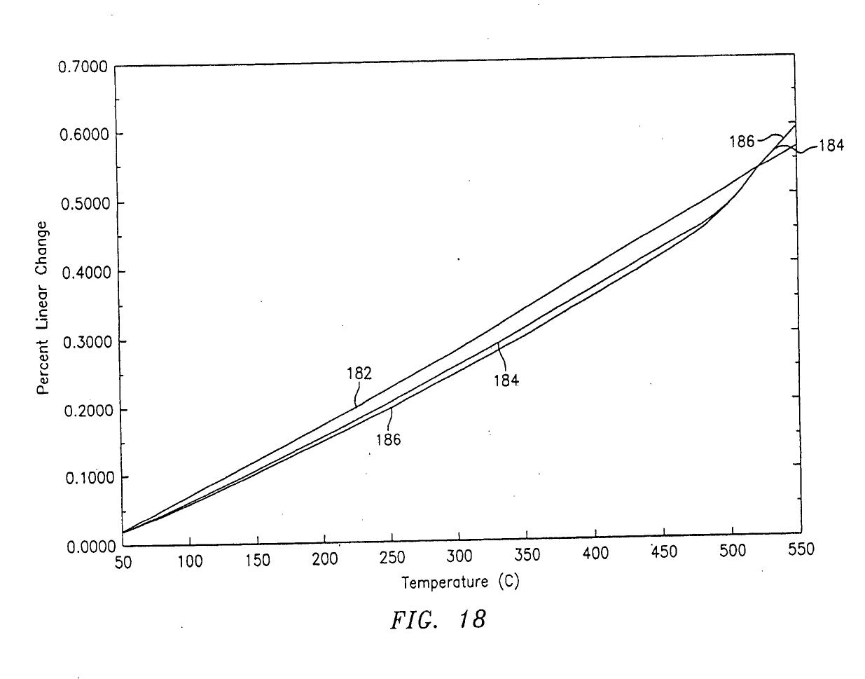

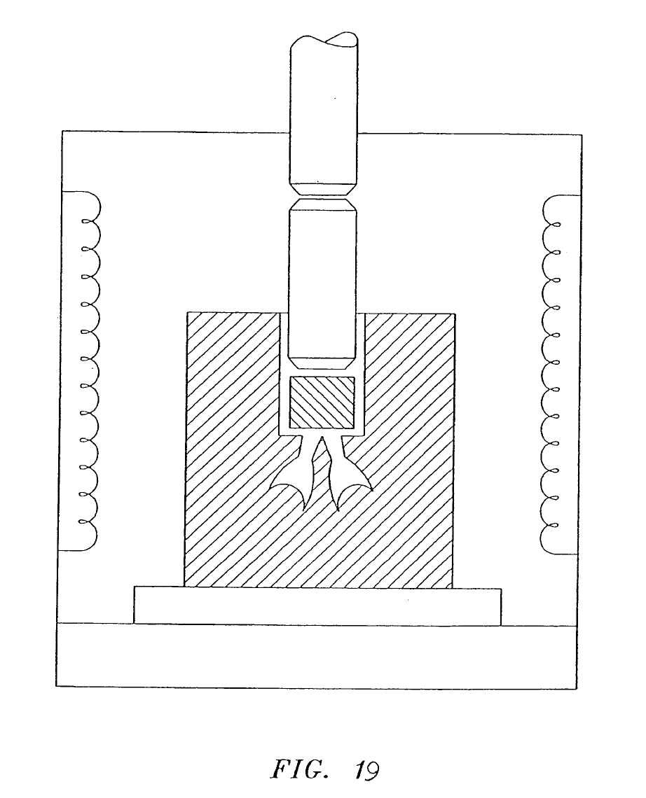

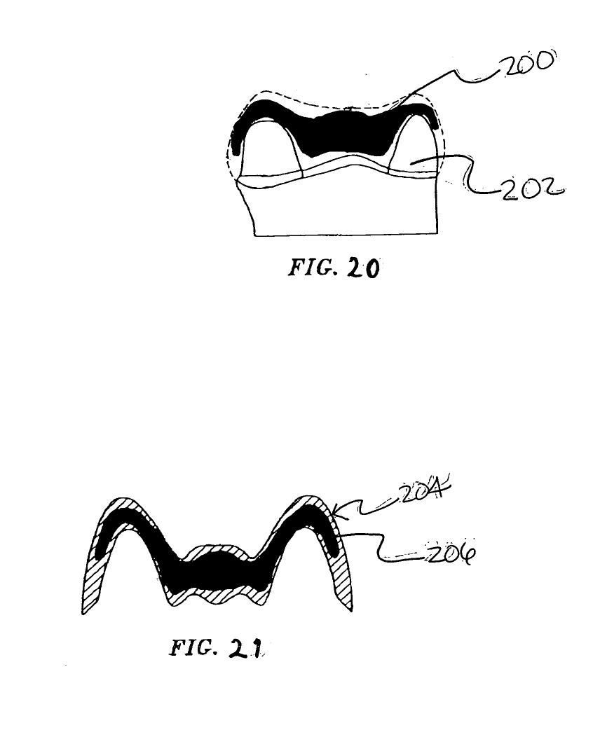

FIG. 10 shows a bridge restoration 100 comprising a bar 102 manufactured from a high strength material such as zirconia. Ceramic material 102 such as lithium disilicate is shown on and around bar 104 forming the bridge restoration 100. Ceramic material 102 may be applied to bar 104 in the form of a tape 110 as shown in FIG. 11, putty 120 as shown in FIG. 12, powder 130 as shown in FIG. 13 or a pellet 168 as shown in FIG. 16 and hereinafter described. FIG. 14 shows zirconia bar 140 which may be ground and or cut to the desired shape as shown in FIG. 15 to form a dental restoration 150.

FIG. 16 shows a mold 160 made using the lost wax process having sprues 162 formed therein to allow material to enter mold 160. A high strength bar 164 is positioned in mold 160 and acts as a reinforcement component for the dental restoration to be formed. As shown in FIG. 16, the mold is encased in a refractory die material 166. Mold 160 does not completely cover bar 164 at points 164t (top) and 164b (bottom) and a high heat refractory material 166 (such as a die material) is in contact at points 164t and 164b to maintain the position of bar 164 as the wax is burned out and mold 160 is formed. Mold 160 is subsequently filled with a ceramic material to form the exterior of the dental restoration, for example by pressing a pellet of material 168 as shown by the arrow at the top of FIG. 16. FIG. 17 shows a dental bridge restoration 170 after removal from the mold. Uncovered sections 164t and 164b will be covered with a ceramic material such as those materials set forth above that could originally be applied to the bar or a composite material such as those set forth above, for example, particulate filled composite material prior to insertion in the patient's mouth.

The following examples illustrate the invention.

### EXAMPLE 1

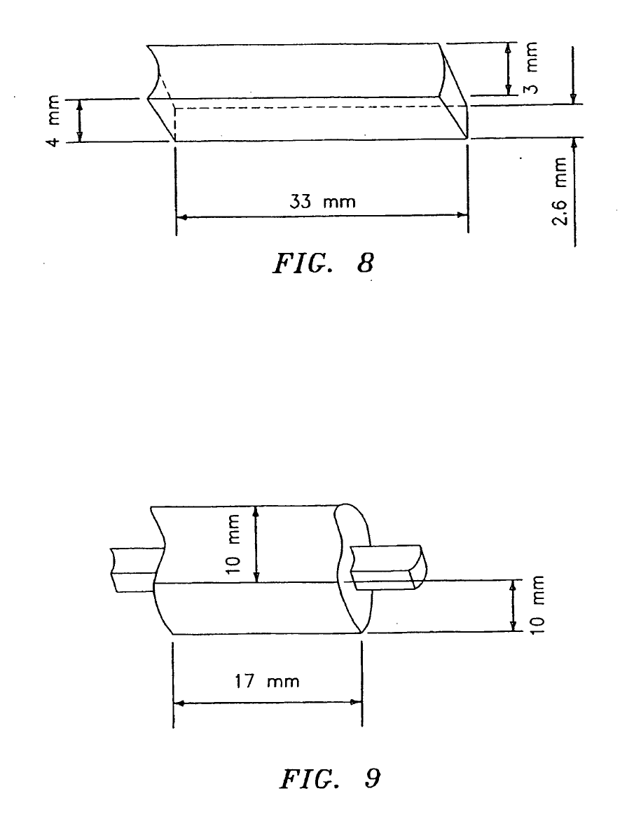

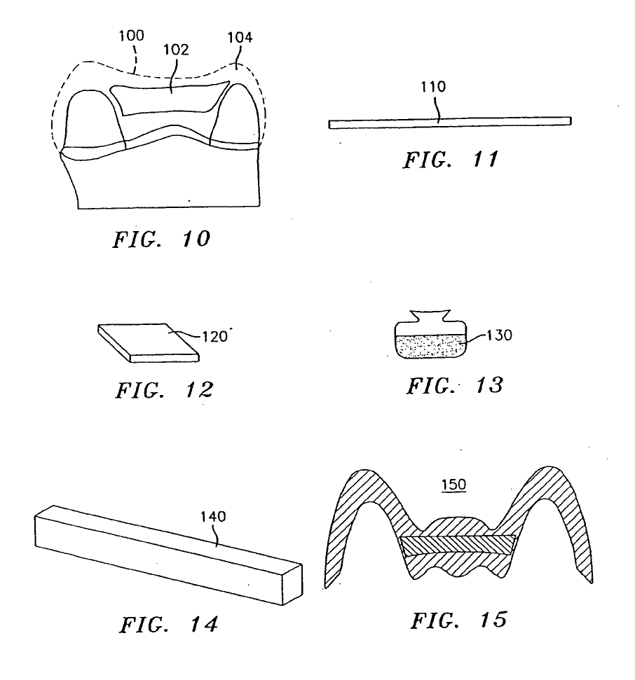

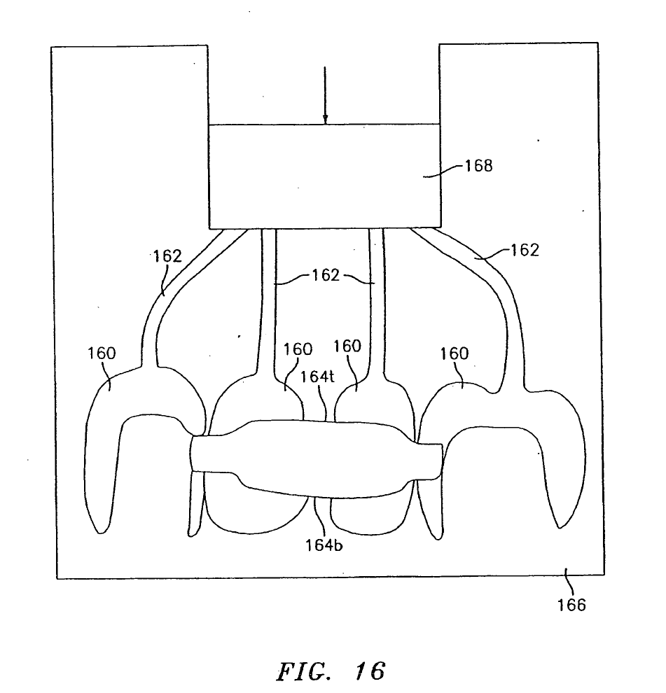

Three-point flexural tests were conducted on zirconia bars having dimensions of 33 mm×4 mm×3 mm whereby the 3 mm side tapers to 2.6 mm and the top of the bar is slightly concave as shown in FIG. 8. The bars were treated as set forth in the Table 3 below to determine the bonding strength between the bars and the veneering layer. The veneering layer was applied along the length of the bar at a span of about 17 mm×10 mm×10 mm as shown in FIG. 9. In example 1, zirconia bars without prior treatment and without a bonding material were tested for strength. In example 2, zirconia bars were heated and a veneering layer was applied without an intermediate bonding layer. In example 3, zirconia bars were heat treated and thereafter coated with a layer of silane. A veneering layer was thereafter applied. In examples 4 through 6, zirconia bars were coated with a bonding layer and heat-treated thereafter to fuse the layer thereto. Veneering layers were then applied to the bonding layer with or without surface treatment or a coupling agent as set forth in Table 3. Table 3 provides the three-point flexural test results for the various examples.

TABLE 3

| | Bonding | Heat | Surface | Veneering | Bending Load |
|---|---|---|---|---|---|
| Material | Material | Treatment | Treatment | Layer | (lbs) |
| 1. Zirconia Bars | none | none | none | none | 227 |
| (as received) | | | | | |
| 2. Zirconia Bars | none | 960° C. | none | Sculpture ® | 198 |
| | | | | Resin | |
| 3. Zirconia Bars | none | 960° C. | silane | Sculpture ® | 189 |
| | | | | Resin | |
| 4. Zirconia Bars | Tyspar ™ | 857° C. | silane & | Sculpture ® | 226 |
| | porcelain** | | thinning | Resin | |
| | | | liquid | | |
| 5. Zirconia Bars | Vitadurn ™ | 960° C. | none | Sculpture ® | 210 |
| | porcelain*** | | | Resin | |
| 6. Zirconia Bars | ColorMatch ® | 938° C. | silane & | Sculpture ® | 215 |
| | porcelain* | | thinning | Resin | |
| | | | liquid | | |

*ColorMatch is a registered trademark of Jeneric/Pentron Inc., Wallingford, CT.
**Tyspar is a trademark of American Thermocraft Corporation, Somerset, NJ.
***Vitadurn is a trademark of Vita Zahnfabrik, Bad Sackingen, Germany.

The results in Table 3 show the bond strength obtained between the zirconia bars and the resin materials when an intermediate bonding layer is used. Example 1 exhibits the strength of the zirconia. The bars which were coated with a bonding material (Examples 4-6) show strengths similar to strengths of the as received bars of Example 1 which had no prior treatment. When no bonding layer was used, the bonding strength decreased. Dental materials and restorations having high strength structural components are appreciated by the invention wherein a bonding layer is applied to the ceramic component by fusion, sputtering, chemical vapor deposition, ion bombardment, vacuum deposition and the like to achieve a layer to which a resin, composite, ceramic, or like material will easily bond to.

### EXAMPLE 2

Zirconia bars (length=70 mm, height=4 mm, width tapered from 2.5 mm to 3 mm) received from Friatec Aktiengesellschaft (Division Frialit-Degussit, Mannheim, Germany) were thinned down using 120 grit silicon carbide sand paper, cut into smaller sections with a high-speed hand-piece equipped with a diamond wheel and further shaped using white stone (made from alumina). This tetragonal zirconia polycrystalline (TZP) material was relatively easily cut by the diamond wheel and was even lightly shaped by a conventional white stone made from alumina. It was found also that lithium disilicate glass-ceramic material (OPC®3G® ceramic material available from Pentron Laboratory Technologies, LLC) is not only expansion compatible to the zirconia (TZP) material but wets and bonds very well to this zirconia material. To illustrate the application of these materials for multi unit dental restorations a three-unit bridge was built on a refractory model made from Polyvest Refractory Die Material (Whip Mix Corp., Louisville, Ky.) as per manufacturer instructions. The Polyvest model was soaked in distilled water for 3 minutes prior to core build-up. Identical frameworks were fabricated using the −200 mesh powders made from the lithium disilicate glass-ceramic compositions set forth in Table 2 below. Average particle size of both powders was about 35 microns. Specifically, the glass-ceramic of composition 2 is similar to OPC®3G® pellet material. The powders were mixed with water to thick paste consistency. The core was built on the Polyvest refractory die in three consecutive applications as described below. First, the lithium disilicate powder was applied on the abutments as a thin coat and fired at a temperature given in the table below. Second, one of the abutments was built to nearly full contour with a hole in a proximal surface. The zirconia insert made as described above was set in a hole and balanced on the die. After the second bake (at the same temperature as the first bake) the zirconia insert was permanently fused into one of the abutments. In the third application both abutments and pontic were built to complete the required core geometry. After the third bake at the same temperature, the lithium disilicate core with zirconia reinforcement was complete. The cores made from compositions 1 and 2 were mounted in epoxy, sectioned and polished through 120 and 400-grit sandpaper. Polished cross-sections were studied using optical microscope at magnifications of 50× and 200×. Cores were found to be fully dense. Interface between zirconia and lithium disilicate material was carefully inspected and no cracks, bubbles, debonding or delamination were found. One of the bridge cores (frameworks) made from composition 2 was fully completed using OPC®3G® porcelain. The fired three-unit framework reinforced with the zirconia insert was further overlaid with OPC® 3G® porcelain. After porcelain was fired, the resulting bridge was found to be more than adequate in aesthetics and function. To confirm the thermal expansion compatibility between lithium disilicate glass ceramics and TZP zirconia the thermal expansion of both was measured and the resulting expansion curves overlaid as depicted in FIG. 18. Line 182 depicts the thermal expansion curve of zirconia. Line 184 depicts the thermal expansion of composition 1 set forth in Table 2 below. Line 186 depicts the thermal expansion of composition of composition 2 set forth in Table 4 below.

TABLE 4

| LithiumDisilcate | | |
|---|---|---|
| Glass-Ceramic | 1 | 2 |
| SiO₂ | 68.7 | 68.8 |
| B₂O₃ | — | 1.2 |
| Al₂O₃ | 4.8 | 4.8 |
| CaO | 1.0 | 1.0 |
| BaO | 2.8 | 2.8 |
| Li₂O | 14.4 | 14.4 |
| K₂O | 2.2 | 2.2 |
| Na₂O | 1.5 | 1.4 |
| P₂O₅ | 3.3 | 3.3 |
| Tb4O₇ | 0.7 | — |
| CeO₂ | 0.7 | — |
| Firing | 890° C. × | 880° C. × |
| Temperature | 1 min. hold | 1 min. hold |

### EXAMPLE 3

Glass-ceramic compositions of the present invention were utilized to make glass-ceramic pellets. Glasses of compositions given in Table 5 were batched from the corresponding mixtures of carbonates, oxides and monoammonium phosphate (such as shown in Table 6 below for Examples 6 and 8) and melted at 1300° C. for 4 hours in fused silica crucibles. A portion of the molten glass was cast into steel molds to form pellets and the rest was quenched into water. Cast ingots having the shape of nine cylindrical pellets (D=11 mm, H=16 mm) attached to rectangular stems were quickly transferred from the steel molds to the annealing furnace operating at 450° C. The ingots were annealed for approximately 30 minutes and furnace-cooled. The water-quenched glass was separated from the water and dried. For the glass compositions of Examples 6 and 8, a portion of the quenched glass was separated and milled as a glass and the rest of the glass was loaded into fused silica crucibles for crystallization heat treatment in bulk.

TABLE 5

| Raw batch | | |
|---|---|---|
| composition, wt % | Ex 6 | Ex 8 |
| K₂CO₃ | 2.532 | 2.484 |
| Ta₂O5 | 0 | 1.580 |
| Li₂CO₃ | 27.845 | 27.320 |
| H₃BO₃ | 1.735 | 1.702 |
| CaCO₃ | 1.41 | 1.383 |
| CeO₂ | 0 | 0.304 |
| Na₂CO₃ | 1.939 | 1.902 |
| SiO₂ | 53.826 | 52.811 |
| Al₂O₃ | 3.729 | 3.659 |
| BaCO₃ | 2.783 | 2.731 |
| NH₄H₂PO₄ | 4.202 | 4.123 |

The compositions of Example 6 and 8 were used to fabricate glass-ceramic pellets using three alternative processes described earlier, namely (1) the parent glass was cast into the shape of cylindrical blanks (pellets) and the pellets were heat-treated to form glass-ceramic pellets referred to below as cast-crystallized pellets; (2) the parent glass was quenched, subjected to heat-treatment to crystallize it in bulk and the resulting glass-ceramic was pulverized into powder, the glass-ceramic powder was compacted into the shape of pellets which were sintered to full density under vacuum and referred to as sintered pellets; (3) the parent glass was quenched, milled into powder, the glass powder was compacted into the shape of pellets which were sintered with simultaneous crystallization to form glass-ceramic pellets referred to below as powder-crystallized pellets. Glass pellets and the quenched glass in processes (1) and (2), respectively, were heat treated using the same two-step volume crystallization cycle comprising heating in air at the rate of 10° C./min to 500° C., holding for 2 hours at this temperature, increasing the temperature at a rate of 10° C./minute to 850° C., and holding at this temperature for 4 hours. In process (3) powder-crystallized pellets were pressed from glass powder and sintered/crystallized in a dental furnace using a cycle comprising heating in vacuum at the rate of 20° C./minute to 900° C., no hold.

These three types of pellets were used to make rectangular bars (23×4×2 mm) and rods (23 mm length×3.2 mm diameter) for measuring flexural strength in a standard 3-pt bending fixture described in ISO 6872 specification. The process was the same as that used to make dental restorations. The specimens were pressed into the cavities of refractory investment molds formed by the conventional lost-wax technique using well-described heat-pressing methods (referred to as well as injection-molding of dental glass-ceramics). Heat-pressing was carried out under vacuum in an AutoPress® dental pressing furnace (Pentron Laboratory Technologies, LLC, Wallingford, Conn.). The pressing cycle comprised heating from about 700° C. to about 920° C. and holding at the latter temperature for about 20 minutes prior to applying pressure. Pressure of 0.55 MPa (5.5 bars) was applied for about 7 minutes through a mold plunger assembly schematically shown in FIG. 19. Results of the 3-pt flexure tests for glass-ceramic pellets fabricated by three alternative processes described above for glass-ceramic compositions of Examples 6 and 8 are summarized in the Table 6 below.

TABLE 6

| | Glass-Ceramic Composition | | | | | |
|---|---|---|---|---|---|---|
| | Example 6 | | | Example 8 | | |
| | CAST- | | POWDER- | CAST- | | POWDER- |
| Pellet type | CRYSTALLIZED | SINTERED | CRYSTALLIZED | CRYSTALLIZED | SINTERED | CRYSTALLIZED |
| 3-pt Flexure | 420 ± 60 | 290 ± 40 | 250 ± 30 | 440 ± 60 | | |
| Strength per | | | | | | |
| ISO 6872, | | | | | | |
| MPa | | | | | | |
| As-Pressed | 370 ± 40 | 320 ± 20 | 260 ± 20 | 370 ± 30 | 270 + 40 | 300 ± 20 |
| Rod | | | | | | |
| (D = ⅛″) 3- | | | | | | |
| pt Flexure | | | | | | |
| Strength, | | | | | | |
| MPa | | | | | | |

Comparing the strength values obtained for the various types of pellets, the cast-crystallized pellets exhibited the highest flexure strength compared to the other two types of pellets and were fabricated with the least number of processing steps involved. The noticeable decrease in strength for the sintered and powder-crystallized pellets was attributed to accumulation of processing flaws introduced during the extra processing steps, especially the vacuum sintering step required to produce these types of pellets. The cast crystallized pellets herein generally have a 3-point flexure strength exceeding about 350 MPa and preferably equal to or greater than about 370.

Moreover, the closeness of refractive indices of the matrix glass (˜1.5) and that of the crystallized phase-lithium disilicate-(˜1.55) allows for the possibility of translucent glass-ceramics. Specifically in the present invention, the refractive index of the glass matrix is increased to match that of the lithium disilicate phase by adding small amounts of heavy ions such as, but not limited to, Sr, Y, Nb, Cs, Ba, Ta, Ce, Eu and Tb.

The following examples in Table 7 illustrate the effect of different additions on translucency, strength and reactivity with investment of the resulting glass-ceramics. The composition of Example 6 (Table 2) was selected as a control composition for the purposes of this study. This composition was modified by adding 0.13 mole % of CeO₂, or 0.06 mole % of Tb₄O₇, or 0.26 mole % of Ta₂O₅, or La₂O₃, or Y₂O₃; and combinations of the latter with CeO₂. Opacity was measured on the pressed disk using an optical densitometer. Reactivity with investment was evaluated qualitatively by visual inspection of disks and copings prior to and after sand-blasting of the reaction layer. Surfaces of the disks were inspected for pittings under low-magnification (8×) stereomicroscope. Compositions comprising combinations of Ta₂O₅, and CeO₂ were found to have the best combination of high translucency (low opacity) and low reactivity with the investment.

TABLE 7

| | Ex. | | Ex. | Ex. | | Ex. | Ex. | | Ex. | Ex. |
|---|---|---|---|---|---|---|---|---|---|---|
| Oxide, wt % | 6* | Ex. 16 | 17 | 18 | Ex. 19 | 20 | 21 | Ex. 22 | 8* | 23 |
| SiO₂ | 68.8 | 68.12 | 68.5 | 68.2 | 67.5 | 67.8 | 67.9 | 68.0 | 67.2 | 67.5 |
| B₂O₃ | 1.3 | 1.2 | 1.2 | 1.2 | 1.2 | 1.2 | 1.2 | 1.2 | 1.2 | 1.2 |
| Al₂O₃ | 4.8 | 4.7 | 4.8 | 4.7 | 4.7 | 4.7 | 4.7 | 4.7 | 4.7 | 4.7 |
| CaO | 1.0 | 1.0 | 1.0 | 1.0 | 1.0 | 1.0 | 1.0 | 1.0 | 1.0 | 1.0 |
| BaO | 2.8 | 2.7 | 2.8 | 2.7 | 2.7 | 2.7 | 2.7 | 2.7 | 2.7 | 2.7 |
| Li₂O | 14.4 | 14.3 | 14.3 | 14.3 | 14.1 | 14.2 | 14.2 | 14.2 | 14.1 | 14.1 |
| K₂O | 2.2 | 2.2 | 2.2 | 2.2 | 2.2 | 2.2 | 2.2 | 2.2 | 2.2 | 2.2 |
| Na₂O | 1.5 | 1.4 | 1.5 | 1.4 | 1.4 | 1.4 | 1.4 | 1.4 | 1.4 | 1.4 |
| P₂O₅ | 3.3 | 3.3 | 3.3 | 3.3 | 3.3 | 3.3 | 3.3 | 3.3 | 3.2 | 3.3 |
| Y₂O₃ | — | 1.04 | — | — | — | — | 1.04 | — | — | — |
| CeO₂ | — | — | 0.39 | — | — | — | 0.39 | 0.39 | 0.39 | 0.39 |
| Tb₄O₇ | — | — | — | 0.85 | — | — | — | 0.85 | — | — |
| Ta₂O₅ | — | — | — | — | 2.02 | — | — | — | 2.01 | — |
| La2O3 | — | — | — | — | — | 1.5 | — | — | | 1.49 |
| Molar ratio | 1.777 | 1.765 | 1.777 | 1.765 | 1.765 | 1.765 | 1.765 | 1.765 | 1.765 | 1.765 |
| of (Na₂O + K₂O + CaO + | | | | | | | | | | |
| SrO + BaO):(ZnO + Al₂O₃) | | | | | | | | | | |
| 3-pt Flexure Strength | 420 ± 60 | | | | | | | | 440 ± 60 | |
| per ISO 6872, | | | | | | | | | | |
| MPa | | | | | | | | | | |
| As-Pressed Rod | 370 ± 40 | | | | | | | | 370 ± 30 | |
| 3-pt Flexure Strength, | | | | | | | | | | |
| MPa | | | | | | | | | | |
| As-pressed Opacity | 42 | 35 | 39 | 37 | 27 | 25 | 31 | 32 | 25 | 24 |
| (relative opacity units) | | | | | | | | | | |
| Reactivity with | — | Medium | Lower | Higher | Medium | Higher | Lower | Medium | Lower | The |
| investment | | | | | | | | | | Highest |
| material | | | | | | | | | | |

*Correspond to compositions in Table 2.

### EXAMPLE 4

Pellets of the compositions of Examples 2, 6, 8 and 9 were used to press a variety of dental articles in the AutoPress® dental press (Pentron Laboratory Technologies, LLC, Wallingford, Conn.) at pressing cycles carried out under vacuum and involving heating from 700° C. to 920° C. and holding the temperature for 20 minutes prior to initiation of the pressing cycle. Pressure of 0.5 MPa was applied for 7 minutes through a mold-plunger assembly schematically shown in FIG. 19. The plunger assembly used to press the pellets into dental restorations may be a system such as that set forth in copending commonly assigned U.S. Pat. No. 6,302,186, which is hereby incorporated by reference. Disks of compositions of examples 11 and 13 were pressed as described above and chemical solubility was measured according to ISO 6872 and found to be significantly lower than the acceptable limit of 100 μg/cm².

To further increase the strength of the dental restorations produced by an injection-molding method the cast-crystallized pellets of the composition of Example 8 were used to press frameworks for four-unit anterior bridges and three unit posterior bridges with pontics reinforced by structural elements made from yttria-stabilized tetragonal zirconia (YTZP) bars. FIG. 2 shows a YTZP bar 20 used for reinforcing dental products.

YTZP bars (length=70 mm, height=4 mm, width tapered from 2.5 mm to 3 mm) received from Friatec Aktiengesellschaft (Division Frialit-Degussit, Mannheim, Germany) were thinned down using 120 grit silicon carbide sand paper, cut into smaller sections with a high-speed hand-piece equipped with a diamond wheel and further shaped using white stone (made from alumina). Surprisingly this YTZP material was relatively easily cut by a diamond wheel and could be ground and shaped by conventional white stone made from alumina.

These four-unit anterior and three-unit posterior frameworks were waxed up on a stone model at which time the structural elements were inserted into the wax model of the framework as shown in FIG. 3. A reinforcing bar 30 is placed on stone model 32 and wax 34 is built up around bar 30. These hand-made structural elements fabricated manually from the commercially available YTZP material in the shape of bars and using tools readily available in each dental lab were relatively easily integrated into the wax-ups of the bridges suggesting that pre-fabricated YTZP pontics (inserts) can be used with even greater ease and convenience.

FIG. 4 shows a YTZP reinforcing bar 40 enclosed in a lithium disilicate framework 42 made in accordance herein. FIG. 5 shows the pressing of a four-unit framework with a YTZP reinforcing bar 50 therein. A lithium disilicate pellet 52 manufacture in accordance herein is shown in pressing position. FIG. 6 shows the finished pressed lithium disilicate framework 52F made from pellet 52 from FIG. 5 for a four-unit anterior bridge with YTZP reinforcing bar 50 therein.

Some of the pressed frameworks were sectioned to evaluate the integrity of the interface between the lithium-disilicate glass-ceramic and the YTZP structural elements (inserts). Surprisingly it was as well found that lithium disilicate glass-ceramic material of this invention is not only compatible in thermal expansion to the YTZP material but wets and bonds very well to this YTZP material.

The remaining pressed frameworks were veneered with OPC® 3G® Porcelain (Pentron Laboratory Technologies LLC, Wallingford, Conn.) compatible both with lithium-disilicate glass-ceramics of the present invention and YTZP material.

### EXAMPLE 5

Three different powders of lithium disilicate glass-ceramics given in Table 8 below were used to make jacket crowns. One powder was formed from the composition of Example 24, a second powder was formed from fifty percent of the composition of Example 25 and fifty percent of the composition of Example 26, and a third powder was formed from the composition of Example 26. The powders were mixed with water to a thick paste consistency and were applied to refractory dies made form Polyvest Refractory Die Material available from Whip Mix Corp., Louisville, Ky. and Synvest Refractory Die Material available from Pentron Laboratory Technologies, LLC, Wallingford, Conn. Both investments were found adequate. Cores were built up in two applications and fired as given below. The first application was fairly thin. Fired cores were sectioned, polished with 120 and 400 grit sandpaper. Polished cross-sections were studied using an optical microscope at magnifications of 50× and 200×. Cores were found to be fully dense. Only occasionally pores smaller than 30 um were observed. Some of the copings were built up to full crowns using OPC® 3G® porcelain available from Pentron Laboratory Technologies, LLC, Wallingford, Conn. and found to be more than adequate in aesthetics and function. Additionally, the powder of composition 26 was wet-condensed into bars. The bars were fired and polished as per ISO-6872. Three-point bend testing was conducted on ten bars and the flexure strength was measured to be 241±25.

TABLE 8

| | composition | | | | | |
|---|---|---|---|---|---|---|
| | | | | | 26 (=11 from | |
| | 24 | | 25 | | Table 3) | |
| oxide | Wt % | Mole % | Wt % | Mole % | Wt % | Mole % |
| SiO₂ | 68.7 | 64.08 | 70.6 | 64.73 | 68.8 | 63.68 |
| B₂O₃ | — | — | 0.9 | 0.71 | 1.2 | 1.00 |
| Al₂O₃ | 4.8 | 2.64 | 4.8 | 2.59 | 4.8 | 2.62 |
| ZnO | 0 | 0.00 | 0 | 0.0 | 0 | 0.00 |
| MgO | 0 | 0.00 | 0 | 0.0 | 0 | 0.00 |
| SrO | 0 | 0.00 | 0 | 0.0 | 0 | 0.00 |
| CaO | 1.0 | 1.0 | 0.5 | 0.49 | 1.0 | 0.99 |
| BaO | 2.8 | 1.02 | 1.4 | 0.50 | 2.8 | 1.02 |
| Li₂O | 14.4 | 27.01 | 14.7 | 27.10 | 14.4 | 26.80 |
| K₂O | 2.2 | 1.31 | 2.1 | 1.23 | 2.2 | 1.30 |
| Na₂O | 1.5 | 1.36 | 1.4 | 1.24 | 1.4 | 1.30 |
| ZrO₂ | 0 | 0.00 | 0 | 0.00 | 0 | 0.00 |
| TiO₂ | 0 | 0.00 | 0 | 0.00 | 0 | 0.00 |
| P₂O₅ | 3.3 | 1.30 | 3.6 | 1.40 | 3.3 | 1.29 |
| Tb₄O₇ | 0.7 | 0.05 | 0 | 0.00 | 0 | 0.00 |
| CeO₂ | 0.7 | 0.23 | 0 | 0.00 | 0 | 0.00 |

| | | | |
|---|---|---|---|
| Molar Ratio of | 1.78 | 1.34 | 1.76 |
| (Na₂O + K₂O + | | | |
| CaO + SrO + BaO)/ | | | |
| (Al₂O₃ + ZnO) | | | |
| Firing Temperature | 890° C. × | 890° C. × | 890° C. × |
| | 1 min hold | 1 min hold | 1 min hold |

The glass-ceramics of the present invention have the capability to be used to fabricate dental articles using powder application techniques, pressing techniques or machining techniques to provide single or multi-unit dental restorations at temperatures below about 950° C. using already existing, commercially available equipment such as the Autopress® available from Pentron Laboratory Technologies, LLC, Wallingford, Conn. Pressability or ability to flow and be pressed into complex shapes of dental restorations at these temperatures is achieved due to the presence of a sufficient amount of the residual glass in the resulting glass-ceramic, in the range of about 15%-60% by volume. The glass-ceramics of the present invention have the capability to be shaded by admixing pigments to the glass-ceramic powder by methods commonly used for dental porcelains, or alternatively, to the glass batch prior to melting the starting glass composition.

While various descriptions of the present invention are described above, it should be understood that the various features can be used singly or in any combination thereof. Therefore, this invention is not to be limited to only the specifically preferred embodiments depicted herein.

Further, it should be understood that variations and modifications within the spirit and scope of the invention may occur to those skilled in the art to which the invention pertains. Accordingly, all expedient modifications readily attainable by one versed in the art from the disclosure set forth herein that are within the scope and spirit of the present invention are to be included as further embodiments of the present invention. The scope of the present invention is accordingly defined as set forth in the appended claims.

1. A lithium disilicate dental product made with glass-ceramic blanks formed by the process comprising:
melting a starting glass composition at temperatures within the range of about 1200 to about 1600° C.;
forming the molten glass into shaped blanks;
annealing the glass blanks at temperatures in the range of 300° to about 600° C. for a time in the range of about 15 minutes to about 8 hours;
subjecting the glass blanks to one or more heat treatments in the temperature range of from about 400° to about 1100° C. to convert the glass blanks into glass-ceramic blanks; and
wherein the dental restoration comprises a high strength reinforcing bar.

2. The dental product of claim 1 wherein the high strength reinforcing bar comprises zirconia, alumina, SIALON, mullite, titanium oxide, magnesium oxide and composites or mixtures thereof.

3. The dental product of claim 2 wherein the high strength reinforcing bar comprises a mixture of zirconia and yttria.

4. The dental product of claim 1 wherein the blank comprises a 3-point flexure strength exceeding about 350 MPa.

5. The dental product of claim 4 wherein the 3-point flexure strength is greater than about 370 MPa.

6. The dental product of claim 1 wherein the bar is square, rectangular, triangular, rhomboidal, ovoidal, or cylindrical.

7. The dental product of claim 1 wherein the blank is pressed into the dental product around the high strength reinforcing bar.

8. The dental product of claim 1 wherein crystallization of lithium disilicate is effected in the glass blanks after annealing when subjected to one or more heat treatments in the temperature range of from about 400° to about 1100° C.

9. The dental product of claim 1 wherein subjecting the glass blanks to one or more heat treatments in the temperature range of from about 400° to about 1100° C. comprises a first nucleation step and a second crystal growth step.

10. The dental product of claim 9 wherein the first nucleation step comprises heating the molten glass to a temperature in the range of about 450° to about 700° C.

11. The dental product of claim 9 wherein the second crystal growth step comprises heating the nucleated glass in the range of about 800° to about 1000° C.

12. The dental product of claim 9 wherein the first nucleation step comprises heating the molten glass to a temperature in the range of about 500° to about 650° C.

13. The dental product of claim 9 wherein the second crystal growth step comprises heating the nucleated glass in the range of about 830° to about 930° C.

14. The dental product of claim 9 wherein the first nucleation step comprises about a one hour soak at about 645° C. and wherein the second crystal growth step comprises about a four hour soak at about 850° C.

15. The dental product of claim 1 comprising machining the glass-ceramic blanks into the dental products.

16. The dental product of claim 1 wherein the dental product is a dental core and is provided with one or more coatings.

17. The dental product of claim 16 wherein the one or more coatings is selected from a ceramic, a sintered ceramic, a glass-ceramic, a porcelain, a glass, a glaze, a composite and mixtures thereof.

18. The product of claim 16 wherein the one or more coatings has a firing temperature in the range of about 700° to about 900° C. and a coefficient of thermal expansion (measured from room temperature to its transition temperature) of within about +2.0×10⁻⁶/° C. of the dental product (measured at the same temperature range).

19. The dental product of claim 1 formed into a component selected from the group consisting of orthodontic appliances, bridges, space maintainers, tooth replacement appliances, splints, crowns, partial crowns, dentures, posts, teeth, jackets, inlays, onlays, facing, veneers, facets, implants, abutments, cylinders, and connectors.

20. The dental product of claim 1 wherein the high strength reinforcing bar has a shape that approximates the near-net-shape of the final restoration.

21. A lithium silicate dental restoration made with glass-ceramic powder formed by the process comprising:
melting a starting glass composition at temperatures within the range of about 1200° C. to about 1600° C.;
quenching the glass melt;
subjecting the quenched glass to one or more heat treatments in the temperature range of from about 400° C. to about 1100° C. to convert the glass into a glass-ceramic;
comminuting the glass ceramic to a powder;
forming the powder onto a die to form a dental restoration, wherein the die has a high strength reinforcing bar positioned thereon; and
sintering the formed dental restoration having the high strength reinforcing bar therein.

22. A lithium disilicate dental product made by the process comprising:
melting a starting glass composition at temperatures within the range of about 1200° C. to about 1600° C.;
quenching the glass melt;
subjecting the quenched glass to one or more heat treatments in the temperature range of from about 400° C. to about 1100° C. to convert the glass into a glass-ceramic;
comminuting the glass ceramic to a powder;
compacting the powder to a starting blank;
sintering the blank; and
wherein the dental product comprises a high strength reinforcing bar.
